(19) United States
(12) Patent Application Publication
(10) Pub. No.: US 2011/0169943 A1
(43) Pub. Date: Jul. 14, 2011

(54) Utilizing Polarization Differencing Method For Detect, Sense And Avoid Systems

(75) Inventors: Thomas A. Bachman, II, Hunt Valley, MD (US); Kirk A. Slenker, Hunt Valley, MD (US)

(73) Assignee: AAI Corporation, Hunt Valley, MD (US)

(21) Appl. No.: 12/026,894

(22) Filed: Feb. 6, 2008

Related U.S. Application Data
(60) Provisional application No. 60/888,462, filed on Feb. 6, 2007.

(51) Int. Cl. H04N 7/18; G06K 9/00

(52) U.S. Cl. 348/117; 348/113; 382/103; 348/E07.085

(57) ABSTRACT

A system, method and computer program product provides for avoiding collision between a vehicle and a target object. Pluralities of images from the target object are sensed. Pluralities of polarized images are generated from the sensed images. One or more composite images are calculated from the two or more polarized images by performing an algebraic manipulation between the two or more polarized images. The target object is tracked based on composite images. A set of evasive maneuver instructions are established for the respective hazard associated with the target object.

### CROSS REFERENCE TO RELATED APPLICATIONS

The present application claims the benefit of U.S. Provisional Patent Application No. 60/888,462, entitled “Utilizing Polarization Differencing Method for Detect, Sense and Avoid Systems,” to Bachmann II, Thomas A. et al. (Attorney Docket No. 13346-240847), filed Feb. 6, 2007, which is of common assignee to the present invention, all of whose contents are incorporated herein by reference in their entireties.

### BACKGROUND

1. Field

Exemplary embodiments relate generally to unmanned vehicles, and more particularly to collision avoidance in unmanned vehicles.

2. Related Art

For unmanned vehicles, such as UAVs (Unmanned Aerial Vehicles) to gain access to the National Airspaces (NAS), there is general consensus in most of the world the vehicles must provide the same level of safety as piloted aircraft. Accordingly, the UAVs must provide collision detection by providing equipment to Detect, See and Avoid (DSA) other aircraft flying in the NAS.

In the United States, for example, the Federal Aviation Administration (FAA) regulations require that unmanned aircraft must provide an equivalent level of safety that is comparable to the “see-and-avoid” requirements set for manned aircraft operating in the US NAS. This ability must also be effective for all air traffic, with or without active, transponder-based collision avoidance systems. Vehicles operating in NAS are required to obtain certificates of authorization, which is a time consuming process, or use either chase planes or ground-based observers. Such organizations as the Aeronautical System Center (ASC) and the Air Force Research Laboratory' Sensors Directorate (AFRL/SN) have developed DSA technology in order to meet the FAA's “see and avoid” requirements. Exemplary systems such as the Traffic Alert and Collision Avoidance System (TCAS) and Mode S transponder may potentially satisfy some of the requirements for avoiding air traffic through cooperative technology, but this is yet undetermined. Cooperative technology, for example, uses transponders to establish the position of participating air traffic in order to determine the possibility of a collision. Also, systems and subsystems for providing the “see and avoid” capability against non-cooperative aircraft, meaning without a transponder-based collision avoidance system, are also unavailable.

A few currently considered approaches to providing DSA use infrared and/or visualelectro optic (black and white or color) cameras to look around the aircraft in place of a pilot. The video may then be processed by an on-board computer with software that would attempt to identify other aircraft in or entering the video frame. The problem is that other aircraft below the horizon are embedded in the background clutter of the ground and can be difficult to identify. This requires significant on board processing resources. Furthermore, under common viewing conditions with a high degree of light scatter, for example, haze, the aircraft may not be visible to the cameras. The result is a high false alarm rate and/or an unacceptable detection and identification rate. What is required is a sensing and detecting method and system that compensates for these disadvantages to solve the foregoing problems specifically, and improve the state of technology for unmanned vehicles generally.

### SUMMARY

In an exemplary embodiment a method for avoiding collision between a vehicle and a target object includes: sensing a plurality of images from the target object; generating a plurality of polarized images from the sensed images; calculating one or more composite images from two or more of the polarized images by performing an algebraic manipulation between the two or more polarized images; and tracking the target object based on the composite images.

The vehicle may include an unmanned vehicle and further include at least one of: an unmanned spacecraft (AS) and/or unmanned aircraft system (UAS); a unmanned aerial vehicle (UAV); a remote-piloted vehicle (RPV); an unmanned air combat vehicle (UCAV); a remotely operated aircraft (ROA); a drone; a rocket; and/or a missile.

The vehicle may include a manned vehicle and further include a vehicle operated in an unmanned capacity, wherein the vehicle comprises at least one of: a private airplane and/or jet; a commercial airplane and/or jet; a water vessels comprising at least one of: a boat and/or a ship; a road vehicle; a rail vehicle; and/or a space-going vehicle.

The composite images from the target object may be sensed by any one of: a visual/pixel device; an infrared device; a microwave radar device; and/or a laser device. The visual/pixel device may include any one of a charge coupled camera (CCD) imager and/or a complimentary metal oxide semiconductor (CMOS) imager. The composite images may include a micro-polarizer array, the array including a plurality of polarized pixels.

The calculating step further may include: extracting and/or otherwise algebraically manipulating any one of a degree of polarization, an angle of polarization, and/or a Stokes parameter, associated with the plurality of polarized images.

The target object may include any one of: a moving object; and/or a stationary object. In an embodiment, the method includes generating a time history of the target object based on the composite images obtained and a time history of when the composite images are obtained. For example, the time history may capture any one of: the absolute position of the target object; and/or the relative position of the target object in relation to the vehicle.

The method may also include establishing a set of evasive maneuver instructions for the respective hazard associated with the target object.

In another exemplary embodiment, a system for avoiding collision between a vehicle and a target object includes: a polarimetric imager, the imager including: one or more sensors for sensing a plurality of images from the target object; one or more polarimetric devices operable to generate a plurality of polarized images from the sensed images; and a composite image system operable to calculate one or more composite images from two or more of the polarized images by performing an algebraic manipulation between the two or more polarized images; and

a tracking system operable to track the target object based on the composite images.

The composite images from the target object may be sensed by any one of: a visual/pixel device; an infrared device; a microwave radar device; and/or a laser device. The visual/pixel device may include any one of: a charge coupled camera (CCD) imager and/or a complimentary metal oxide semiconductor (CMOS) imager. The composite images may include a micro-polarizer array, the array including a plurality of polarized pixels.

The calculating step further may include: extracting and/or otherwise algebraically manipulating any one of a degree of polarization, an angle of polarization, and/or a Stokes parameter, associated with the plurality of polarized images.

In system may include an avoidance system operable to establish a set of evasive maneuver instructions for the respective hazard associated with the target object.

In another embodiment, a machine-readable medium provides instructions, which when executed by a computing platform, causes the computing platform to perform operations comprising a method for avoiding collision between a vehicle and a target object, the method including: sensing a plurality of images from the target object; generating a plurality of polarized images from the sensed images; calculating one or more composite images from two or more of the polarized images by performing an algebraic manipulation between the two or more polarized images; and tracking the target object based on the composite images.

Further features and advantages of, as well as the structure and operation of, various embodiments, are described in detail below with reference to the accompanying drawings.

### BRIEF DESCRIPTION OF THE DRAWINGS

The foregoing and other features and advantages of the invention will be apparent from the following, more particular description of exemplary embodiments of the invention, as illustrated in the accompanying drawings. In the drawings, like reference numbers generally indicate identical, functionally similar, and/or structurally similar elements. The drawing in which an element first appears is indicated by the leftmost digits in the corresponding reference number. A preferred exemplary embodiment is discussed below in the detailed description of the following drawings:

FIG. 1 depicts a component level view of a detect, sense- and avoid system for an unmanned vehicle in accordance with exemplary embodiments;

FIG. 2 depicts a system level view of a detect, sense and avoid system for an unmanned vehicle in accordance with exemplary embodiments;

FIG. 3 depicts a system level view of a polarization imager in accordance with exemplary embodiments;

FIG. 4 depicts an exemplary integrated polarization image sensor in accordance with exemplary embodiments;

FIG. 5 depicts an exemplary integrated polarization image sensor camera device in accordance with exemplary embodiments; and

FIG. 6 depicts an exemplary embodiment of a computer system that may be used in association with, in connection with, and/or in place of certain components in accordance with the present embodiments.

### DETAILED DESCRIPTION OF EMBODIMENTS OF THE EMBODIMENTS

Various exemplary embodiments are discussed in detail below including a preferred embodiment. While specific implementations are discussed, it should be understood that this is done for illustration purposes only. A person skilled in the relevant art can recognize that the systems, methods and features provided herein may be used without parting from the spirit and scope of the invention. Furthermore, any and all references cited herein shall be incorporated herein by reference in their respective entireties.

### Exemplary Embodiments

A wide assortment of unconventional vehicles may be employed in accordance with the present embodiments. Included are Unmanned Aircraft Systems (UAS), Unmanned Aircraft (UA), UAV, RPV (Remote-Piloted Vehicle), Unmanned Air Combat Vehicle (UCAV), Remotely Operated Aircraft (ROA), drones, rockets, missiles, and the like. Though used interchangeably, RPV refers to anything controlled externally by remote control, while UAV generally describes an aircraft piloted from the ground or controlled autonomously with an in-flight computer and/or a pre-programmed flight plan. The term ROA was developed by the Federal Aviation Administration (FAA) for correspondence to certain legal requirements. The terms UAS and UA are recently respectively used to refer to the unmanned system and the flying component of the system. The present embodiments also incorporate other vehicles, which may be either piloted or operating in an unmanned mode, such as private and commercial planes, water vessels such as boats and ships, and road and rail vehicles, space-going vehicles, to name a few. For convenience, the term vehicle as used herein shall broadly encompass all such related terms and concepts, and shall not be limited to an unmanned vehicle.

In exemplary embodiments, the vehicle is remotely operated from a ground control station (GCS) system. An exemplary system is set forth in U.S. application Ser. No. 11/32,6452 to Cosgrove et al., published Nov. 30, 2006 as Publ. No. 2006/0271248, of common assignee herewith, and includes a software core controller (SCC), a ground control station (GCS), ground data terminal (GDT), a vehicle-specific module (VSM) graphical user interface (GUI), a pedestal, a pilot box (PB) and an automatic landing system (ALS). In an embodiment thereof, the SCC controls real-time communication between the vehicle and the control/status devices.

The present embodiments incorporate all known “see and avoid” (SA) technologies for collision detection and avoidance, termed “sense and avoid” (SAA) or “detect, sense and avoid” (DSA) in the context of vehicles. The term DSA shall capture the known systems and methods as well as what is described in the embodiments described herein. As used herein, the DSAs may have such capabilities as envelope scanning, time to collision warning, threshold measuring and setting systems, and resolution and performance processing under adverse conditions.

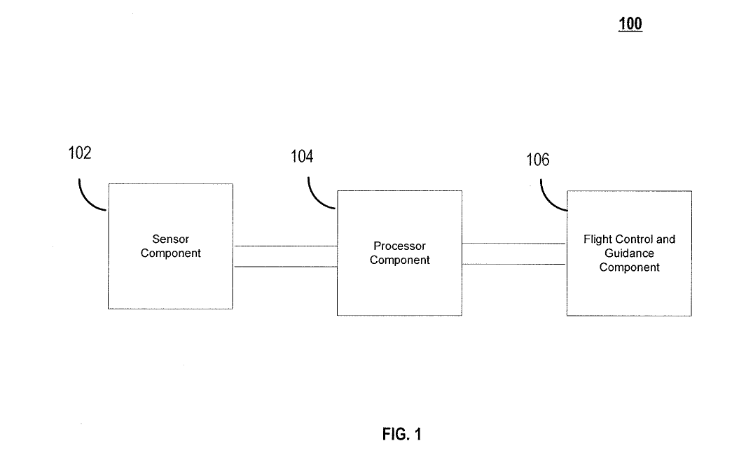

FIG. 1 provides an exemplary DSA system 100 for an exemplary vehicle in accordance with the present embodiments. FIG. 1 includes sensor component 102, processor component 104 and flight control and guidance component 106. Beginning with sensor component 102, the component may include any sensors suitable for use upon a vehicle for detecting target objects within a distance or in vicinity of the vehicle. Exemplary sensors include (i) a visual/pixel device, also called an optical sensor, for detecting the waves coming from an intruding aircraft or other target object, with examples including charge coupled camera (CCD) and/or complementary metal oxide semiconductor (CMOS) imagers, still device cameras and video, light detecting and ranging (LADAR) systems, and the like; (ii) an infrared device and/or thermal systems, which focuses on thermal imaging of the target object; (iii) a microwave radar (millimeter radar) device, an active system that emits a signal within the microwave bandwidth in order to detect the target object within a given range; and (iv) a laser radar device, another active technology where the round trip distances of pulses of light to the target object are used to gauge the distance, with examples including radar detecting and ranging (LADAR) systems, bistatic radar systems, and the like.

Processor component 104 receives the sensed information from sensor component 102 and processes the information. In an exemplary embodiment, the processing is performed in real-time, though later processing is also permitted. In an exemplary embodiment, the later processing is performed for testing purposes. Based on the relevant crisis levels associated with a given target object, the processor component may send a signal to the flight control and guidance component 106. In turn, flight control and guidance component 106 commences the evasive maneuvering capability of the vehicle.

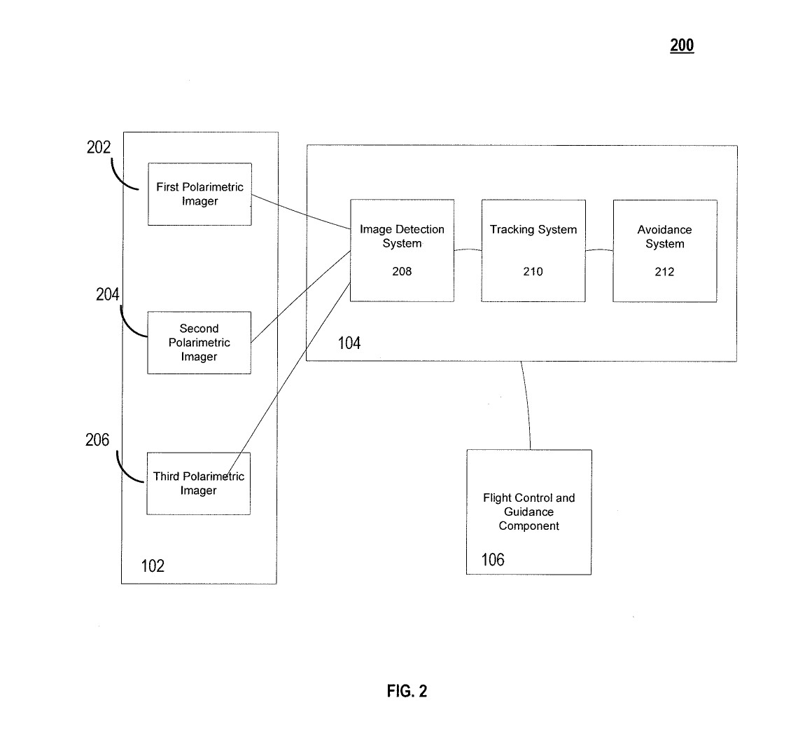

FIG. 2 provides a more detailed view of certain embodiments. Beginning with sensor component 102, the component includes one or more polarization imagers, termed polarimetric 202, 204, 206, which are described in greater detail below. The polarimetric imagers 202-206 may be used as the only imagers, or alternatively, are used in coordination and cooperation with any one or more addition types of image devices.

Processor component 104 includes an image detection system 208, a tracking system 210 and an avoidance system 212. Processor component 104, including its respective components, may employ any type of processing technology capability, including hardware and/or hardware interacting with software. For example, software running on a microprocessor may be used, or a field programmable gate array (FPGA) processor with an embedded processor core may be used. The memory employed may include, for example, random access memory (RAM), of either static (SRAM) or dynamic (DRAM) varieties. The processors may be implemented in series, in parallel, or in a combination of the latter.

Image detection system 208 detects and processes the input from the sensors. In exemplary embodiments where the sensed information comprises video and image images from a visual/pixel or optical sensor device, image detection system 208 performs image detection on a single frame or multi-frame basis. In an exemplary embodiment, the target objects are fed to an object identification subcomponent (not shown) of the image detection system 208, which identifies the target objects in a manner to reduce false alarm rates. The resulting processed information, such as processed images and/or information relating to the processed information, may be transmitted to the tracking system 210. Image detection system 208 may use a suitable methods to suppress background noise and object clutter associated with target object detection. Algorithms may also be used to separate stationary objects from moving objects.

In an exemplary embodiment, the vehicle uses optical flow technology. For exemplary purposes, reference is made, for example, to Mehta, S. and R. Etienne-Cummings, “A simplified normal optical flow measurement CMOS camera,” IEEE Transactions on Circuits and Systems I: Fundamental Theory and Applications, vol. 53, no. 6, June 2006, and Kehoe, J., R. Causey, A. Arvai, and R. Lind, “Partial Aircraft State Estimation from Optical Flow using Non-Model-Based Optimization,” Proceedings of the 2006 IEEE American Control Conference, Minneapolis, Minn., June 2006.

Tracking system 210 may track the intruder target objects. Time histories of detected images from target objects may be built, for example, for the spherical space surrounding the UAV. In an embodiment, the relative motion of the target objects are captured in time histories. Relative crisis and exigency levels may be established for the target objects, based on the time histories. The time history of the target objects may be stored, for example, in local databases, in line of sight or other coordinate systems. In exemplary embodiments, the components are designed to maximize the relevant characteristics of the UAV, including such parameters as size, weight and reliability, in addition to false alarm rates, fields of regards, range, tracking capability, cost, required bandwidth, power requirements, and technical readiness. Any known algorithms for tracking algorithms may be used herewith. Exemplary algorithms employed may, for example, include the ones provided in Yi, Steven and Libin Zhang, “A novel multiple target tracking system for UAV platforms,” J. Proc. of the SPIE, 6209, May 2006, and Sanders-Reed, J. N., “Multi-Target, Multi-Sensor, Closed Loop Tracking,” J. Proc. of the SPIE, 5430, April 2004.

Single frame and multi-frame detection may be employed in accordance with the present embodiments. Reference is made to U.S. application Ser. No. 11/374,807 to Abraham et al., published Sep. 13, 2007 as Publ. No. 2007/0210953, which depicts a single frame mode, where each frame may be convolved with an optical point spread function (OPSF), so that single pixel noise is rejected, and also depicts a multi-frame detection approach, from the teachings of Sanders-Reed, et al., providing isolation of moving targets from stationary ones.

An avoidance system 212 provides intruder or other target object avoidance capability. Avoidance system 212 may establish a unique set of evasive maneuver instructions for the hazard associated with the time history for an target object. The maneuvers may be calculated by avoidance system 212 and transmitted to flight control and guidance component 106, or alternatively, a signal representing the relative hazard level may be transmitted to component 106, which itself generates and coordinates the evasive maneuvering function. Reconstitution of 2- and 3-dimensional trajectories, size and speed ratios and probabilistic assessment of risk assessment may be used as well.

As noted, the exemplary embodiments may be used in either unmanned vehicles, such as UAVs, or conventional vehicles. In exemplary embodiments, flight control and guidance component 106 includes a flight control and guidance processor capable of functioning, for example, in three modes. In the first mode, a pilot-controlled mode, the pilot may control, for example, the ailerons, elevator, throttle and rudder servos, and other components. In the second mode, the remotely piloted mode, the pilot may calibrate gains and sensitivity of the stability and control processors, and gain response for the global positioning system (GPS) steering mode. In the third mode, the UAV mode, autonomous operation may be provided, for example, for the rudders or ailerons coupled to GPS steering commands from the navigation processors, while height and stability may be controlled by stability and control processors. Based on the relevant crisis levels associated with a given target object, the avoidance system 212 may send a signal to the flight control and guidance component 106, which commences the type and duration of the evasive maneuvering capability of the UAV.

A problem dealt with by a number of the present embodiments is improved target object identification. The target object, such as another aircraft, situated below the horizon or embedded in the background clutter of the ground may be quite difficult to identify. This may require significant on-board processing by, for example, processor component 102, or image detection system 208, which may be resource intensive and too heavy for a vehicle that must conserve weight, as well as expensive. Furthermore, under common viewing conditions with a high degree of light scatter, for example, haze, the target object may not be visible or barely visible to devices such as visual/pixel devices. The latter may result in high false alarm rates, or unacceptable detection and identification rates.

The advantage of a polarized image is that the background or scattered light has different polarization characteristics when compared to a man-made aircraft or other man-made target objects. Using polarization differencing, in the present embodiments the background and/or scatter are essentially subtracted or otherwise algebraically manipulated from the image (using Stokes parameters and other variables set forth herein), as the former tend to be more randomly polarized. Targets objects such as man-made aircraft (or other man-made objects) tend to be polarized in a specific plane and are less likely subject to the aforementioned differencing calculations. As a result, in the processed image the background tends to go to a constant color or shade of gray and the aircraft stands out against this background. The procedure reduces the image processing required to automatically detect and track a target object, such as an aircraft in the image, and therefore improves the performance of the sensing elements while reducing the size, weight, and power required by the processing components.

As shown in FIG. 2, the image detection system 208 of processor component 104 combines feeds received from the multiple polarimetric imagers 202-206 of sensor component 102. Though the image detection system is shown separated from the polarimetric imagers 202-206 of sensor component 102, the image detection functionality and associated structural components may be located, for example, directly in the sensor component, or in relation to each individual polarimetric imager; for example, the image detection may be performed individually for each of polarimetric imagers 202-206, and the results and/or resulting information may be fed to tracking system 210 or an analogous device.

In an exemplary embodiment, one of the cameras captures still images, video or other information from the left of the UAV, one of the cameras captures still images, video or other information from the right of the UAV, and one of the cameras captures images, video or other information from the front of the UAV, with or without overlap between the images and/or video. In an exemplary embodiment, the 3 cameras working together capture an image cone of certain degrees from the center, as may be mandated by relevant authorities; in an exemplary such embodiment, the cone captures 110 degrees of images from the center as mandated by the FAA.

Though 3 exemplary cameras are illustrated, any number of cameras may be used in accordance with the embodiments. Furthermore, the number and complexity of the cameras used may be reflective of such significant UAV parameters as weight, size and cost; for example, in an exemplary such embodiment, three high definition cameras may be used, whereas in another exemplary such embodiment, 4, 5, 6 or more relatively low definition cameras may be used.

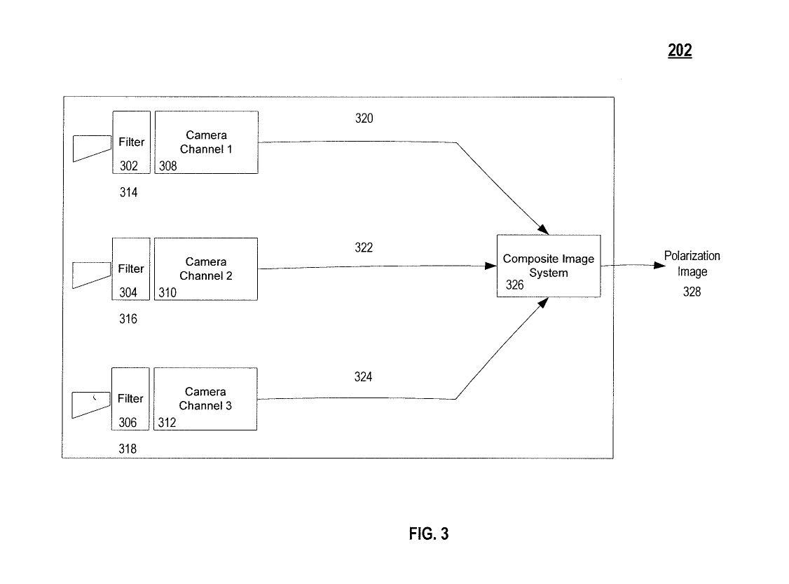

FIG. 3 illustrates the working details of exemplary polarimetric imager 202 (from FIG. 2) in accordance with the certain embodiments. Exemplary polarimetric imager 300 includes multiple polarimetric cameras 314, 316 and 318. Each polarimetric camera includes a lens (not labeled), a filter, and a camera channel. For example, camera 314 includes a lens, filter 302 and camera channel 1 308; camera 316 includes a lens, filter 304 and camera channel 2 310; camera 318 includes a lens, filter 306 and camera channel 1 312.

In an exemplary embodiment, each of the one or more polarization cameras 314-318 polarizes the image at a respective polarization degree. For example, in an exemplary embodiment, the output 320 of polarization camera 314 is an image polarized at 0 degrees, the output 322 of polarization camera 316 is an image polarized at 45 degrees and the output 324 of polarization camera 318 is an image polarized at 90 degrees. Despite the foregoing configuration, any conceivable combination of polarizations may be used. In exemplary embodiments, the polarization of the captured images, data, or other information may be performed separately from the sensing device that captures such images, data, or other information.

Light is by nature a transverse electromagnetic wave made up of mutually perpendicular, fluctuating electric and magnetic fields. Therefore, the fluctuations of the electric field may be viewed in one plane, while the fluctuations in the magnetic field may be viewed in an orthogonal plane. In certain embodiments, the polarization performed is linear, meaning the electric field vector or magnetic field vector is confined to a given plane along the direction of propagation, while other forms of polarization such as circular polarization may be used as well. In exemplary embodiments, the outputs of the polarization cameras may be orthogonal to one another. In certain embodiments, the polarization cameras are CCD and/or CMOS imaging devices. In certain embodiments, at least two different polarization cameras are used. However, any other combination of the foregoing parameters may be used.

In exemplary embodiments, a twisted nematic crystal and/or wire grids may be used to establish the respective polarizations, as referenced in U.S. Pat. No. 5,975,703 to Pugh, Jr. et al., issued Nov. 2, 1999.

The outputs from each polarimetric camera are fed to composite image system 326.

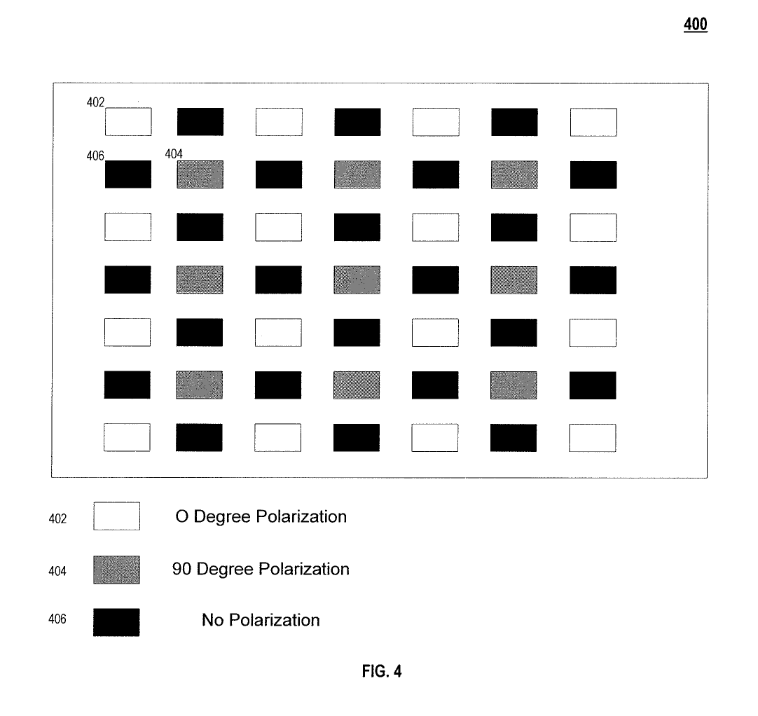

For example, the output 320 of polarimetric camera 314 is fed thereto, as are the output 322 of polarimetric camera 316 and the output 324 of polarimetric camera 318. In exemplary embodiments, one or more outputs from one or more of the polarization cameras 314-318 are subtracted from the outputs from one or more other outputs of the polarization cameras. Composite image system 326 generates a composite image from the three polarization images of the three polarization cameras 314-318, and transmits the resulting image as polarization image 328. The composite image signal may be amplified, filtered and processed for improved performance. The polarization image may be transmitted to image detection system 208 of processor component 104. FIG. 4 provides another exemplary implementation 400. In this implementation, rather than performing polarization on an entire image, differing polarizations are performed on a micro-level, such as on the semiconductor chip. In the exemplary implementation shown, a CMOS image sensor with a micro-polarizer array fixated on its top is illustrated. Each array element 402-406 provides 0 degree polarization (element 402), 90 degree polarization (element 404) or no polarization (element 406) in the illustrated example, though any variety of polarizations may be used.

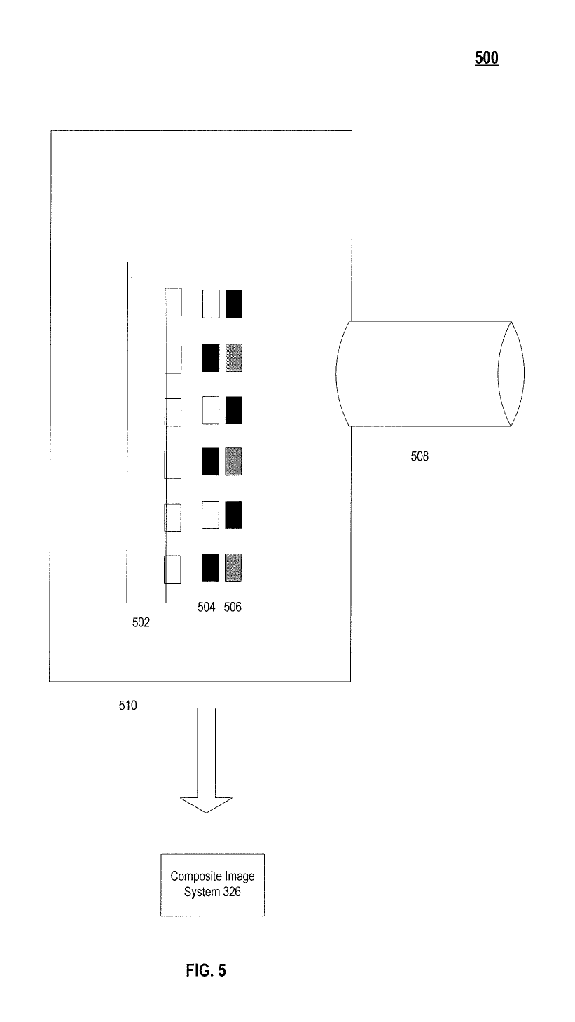

FIG. 5 provides an exemplary camera 510 equipped to perform integrated polarization. The camera includes a lens 508 and camera main area 510. Included within the camera main area 510 are an exemplary CMOS image sensor 502, as well as exemplary 0 degree polarization filters 504, and 90 degree polarization filters 506. The output may be transmitted to composite image system 326.

In an exemplary embodiment, composite image system 326 applies one or more Stokes algorithms in order to determine any of the Stokes parameters (S0, S1, S2, S3) associated with the polarized images. In fact, the degree (magnitude) of polarization, angle of polarization and/or or any of the Stokes parameters may be used to extract and/or otherwise algebraically manipulate information from the image. These measures may be used individually, or in any combination. In an exemplary implementation in relation to FIGS. 4 and 5, each pixel of the generated composite image may have an intensity proportional to any one of the foregoing parameters.

### Exemplary Processing and Communications Embodiments

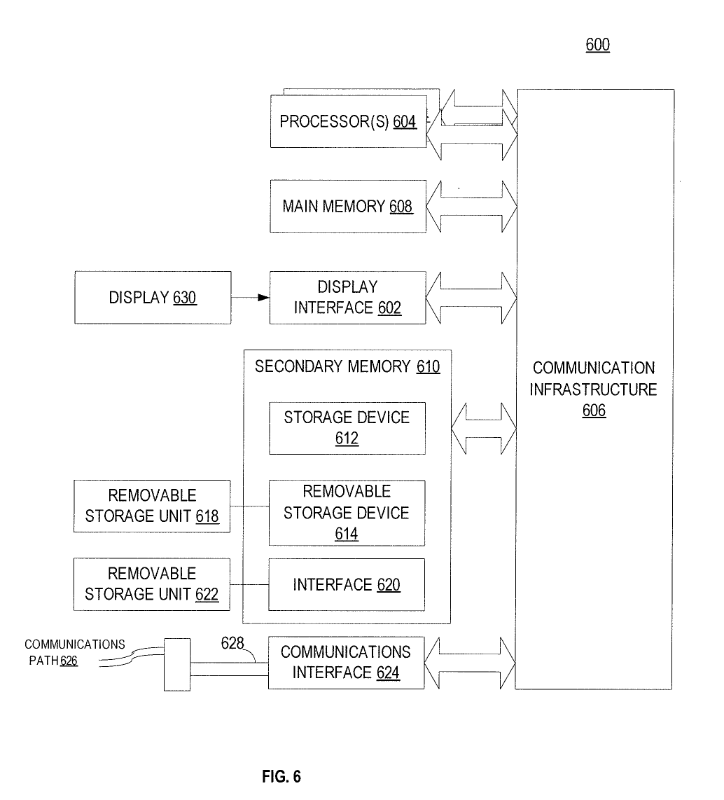

FIG. 6 depicts an exemplary embodiment of a computer system 600 that may be used in association with, in connection with, and/or in place of, but not limited to, any of the foregoing components and/or systems.

The present embodiments (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 600 is shown in FIG. 6, depicting an exemplary embodiment of a block diagram of an exemplary computer system useful for implementing the present invention. Specifically, FIG. 6 illustrates an example computer 600, which in an exemplary embodiment may be, e.g., (but not limited to) a personal computer (PC) system running an operating system such as, e.g., (but not limited to) WINDOWS MOBILETM for POCKET PC, or MICROSOFT® WINDOWS® NT/98/2000/XP/CE/,etc. available from MICROSOFT® Corporation of Redmond, Wash., U.S.A., SOLARIS® from SUN® Microsystems of Santa Clara, Calif., U.S.A., OS/2 from IBM® Corporation of Armonk, N.Y., U.S.A., Mac/OS from APPLE® Corporation of Cupertino, Calif., U.S.A., etc., or any of various versions of UNIX® (a trademark of the Open Group of San Francisco, Calif., USA) including, e.g., LINUX®, HPUX®, IBM AIX®, and SCO/UNIX®, etc. However, the invention may not be limited to these platforms. Instead, the invention may be implemented on any appropriate computer system running any appropriate operating system. In one exemplary embodiment, the present invention may be implemented on a computer system operating as discussed herein. An exemplary computer system, computer 600 is shown in FIG. 6. Other components of the invention, such as, e.g., (but not limited to) a computing device, a communications device, a telephone, a personal digital assistant (PDA), a personal computer (PC), a handheld PC, client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 6.

The computer system 600 may include one or more processors, such as, e.g., but not limited to, processor(s) 604. The processor(s) 604 may be connected to a communication infrastructure 606 (e.g., but not limited to, a communications bus, cross-over bar, or network, etc.). Various exemplary software embodiments may be described in terms of this exemplary computer system. After reading this description, it will become apparent to a person skilled in the relevant art(s) how to implement the invention using other computer systems and/or architectures.

Computer system 600 may include a display interface 602 that may forward, e.g., but not limited to, graphics, text, and other data, etc., from the communication infrastructure 606 (or from a frame buffer, etc., not shown) for display on the display unit 630.

The computer system 600 may also include, e.g., but may not be limited to, a main memory 608, random access memory (RAM), and a secondary memory 610, etc. The secondary memory 610 may include, for example, (but not limited to) a hard disk drive 612 and/or a removable storage drive 614, representing a floppy diskette drive, a magnetic tape drive, an optical disk drive, a compact disk drive CD-ROM, etc. The removable storage drive 614 may, e.g., but not limited to, read from and/or write to a removable storage unit 618 in a well known manner. Removable storage unit 618, also called a program storage device or a computer program product, may represent, e.g., but not limited to, a floppy disk, magnetic tape, optical disk, compact disk, etc. which may be read from and written to by removable storage drive 614. As will be appreciated, the removable storage unit 618 may include a computer usable storage medium having stored therein computer software and/or data.

In alternative exemplary embodiments, secondary memory 610 may include other similar devices for allowing computer programs or other instructions to be loaded into computer system 600. Such devices may include, for example, a removable storage unit 622 and an interface 620. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 622 and interfaces 620, which may allow software and data to be transferred from the removable storage unit 622 to computer system 600.

Computer 600 may also include an input device such as, e.g., (but not limited to) a mouse or other pointing device such as a digitizer, and a keyboard or other data entry device (none of which are labeled).

Computer 600 may also include output devices, such as, e.g., (but not limited to) display 630, and display interface 602. Computer 600 may include input/output (I/O) devices such as, e.g., (but not limited to) communications interface 624, cable 628 and communications path 626, etc. These devices may include, e.g., but not limited to, a network interface card, and modems (neither are labeled). Communications interface 624 may allow software and data to be transferred between computer system 600 and external devices. Examples of communications interface 624 may include, e.g., but may not be limited to, a modem, a network interface (such as, e.g., an Ethernet card), a communications port, a Personal Computer Memory Card International Association (PCMCIA) slot and card, etc. Software and data transferred via communications interface 624 may be in the form of signals 628 which may be electronic, electromagnetic, optical or other signals capable of being received by communications interface 624. These signals 628 may be provided to communications interface 624 via, e.g., but not limited to, a communications path 626 (e.g., but not limited to, a channel). This channel 626 may carry signals 628, which may include, e.g., but not limited to, propagated signals, and may be implemented using, e.g., but not limited to, wire or cable, fiber optics, a telephone line, a cellular link, an radio frequency (RF) link and other communications channels, etc.

In this document, the terms “computer program medium” and “computer readable medium” may be used to generally refer to media such as, e.g., but not limited to removable storage drive 614, a hard disk installed in hard disk drive 612, and signals 628, etc. These computer program products may provide software to computer system 600. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

Computer programs (also called computer control logic), may include object oriented computer programs, and may be stored in main memory 608 and/or the secondary memory 610 and/or removable storage units 614, also called computer program products. Such computer programs, when executed, may enable the computer system 600 to perform the features of the present invention as discussed herein. In particular, the computer programs, when executed, may enable the processor 604 to provide a method to resolve conflicts during data synchronization according to an exemplary embodiment of the present invention. Accordingly, such computer programs may represent controllers of the computer system 600.

In another exemplary embodiment, the invention may be directed to a computer program product comprising a computer readable medium having control logic (computer software) stored therein. The control logic, when executed by the processor 604, may cause the processor 604 to perform the functions of the invention as described herein. In another exemplary embodiment where the invention may be implemented using software, the software may be stored in a computer program product and loaded into computer system 600 using, e.g., but not limited to, removable storage drive 614, hard drive 612 or communications interface 624, etc. The control logic (software), when executed by the processor 604, may cause the processor 604 to perform the functions of the invention as described herein. The computer software may run as a standalone software application program running atop an operating system, or may be integrated into the operating system.

In yet another embodiment, the invention may be implemented primarily in hardware using, for example, but not limited to, hardware components such as application specific integrated circuits (ASICs), or one or more state machines, etc. Implementation of the hardware state machine so as to perform the functions described herein will be apparent to persons skilled in the relevant art(s).

In another exemplary embodiment, the invention may be implemented primarily in firmware.

In yet another exemplary embodiment, the invention may be implemented using a combination of any of, e.g., but not limited to, hardware, firmware, and software, etc.

Exemplary embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

The exemplary embodiment of the present invention makes reference to wired, or wireless networks. Wired networks include any of a wide variety of well known means for coupling voice and data communications devices together. A brief discussion of various exemplary wireless network technologies that may be used to implement the embodiments of the present invention now are discussed. The examples are non-limited. Exemplary wireless network types may include, e.g., but not limited to, code division multiple access (CDMA), spread spectrum wireless, orthogonal frequency division multiplexing (OFDM), 1G, 2G, 3G wireless, Bluetooth, Infrared Data Association (IrDA), shared wireless access protocol (SWAP), “wireless fidelity” (Wi-Fi), WIMAX, and other IEEE standard 802.11-compliant wireless local area network (LAN), 802.16-compliant wide area network (WAN), and ultrawideband (UWB), etc.

Bluetooth is an emerging wireless technology promising to unify several wireless technologies for use in low power radio frequency (RF) networks.

IrDA is a standard method for devices to communicate using infrared light pulses, as promulgated by the Infrared Data Association from which the standard gets its name. Since IrDA devices use infrared light, they may depend on being in line of sight with each other.

The exemplary embodiments of the present invention may make reference to WLANs. Examples of a WLAN may include a shared wireless access protocol (SWAP) developed by Home radio frequency (HomeRF), and wireless fidelity (Wi-Fi), a derivative of IEEE 802.11, advocated by the wireless Ethernet compatibility alliance (WECA). The IEEE 802.11 wireless LAN standard refers to various technologies that adhere to one or more of various wireless LAN standards. An IEEE 802.11 compliant wireless LAN may comply with any of one or more of the various IEEE 802.11 wireless LAN standards including, e.g., but not limited to, wireless LANs compliant with IEEE std. 802.11a, b, d or g, such as, e.g., but not limited to, IEEE std. 802.11 a, b, d and g,(including, e.g., but not limited to IEEE 802.11g-2003, etc.), etc.

### Conclusion

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

1. A method for avoiding collision between a vehicle and a target object, comprising:
sensing a plurality of images from the target object;
generating a plurality of polarized images from the sensed images;
calculating one or more composite images from two or more of the polarized images by performing an algebraic manipulation between the two or more polarized images; and
tracking the target object based on the composite images.

2. The method of claim 1, wherein the vehicle comprises an unmanned vehicle and further comprises at least one of:
an unmanned spacecraft (AS) and/or unmanned aircraft system (UAS);
an unmanned aerial vehicle (UAV);
a remote-piloted vehicle (RPV);
an unmanned air combat vehicle (UCAV);
a remotely operated aircraft (ROA);
a drone;
a rocket; and/or a missile.

3. The method of claim 1, wherein the vehicle comprises a manned vehicle and further comprises a vehicle operated in an unmanned capacity, wherein the vehicle comprises at least one of:
a private airplane and/or a jet;
a commercial airplane and/or a jet;
a water vessel comprising at least one of: a boat and/or a ship;
a road vehicle;
a rail vehicle; and/or
a space-going vehicle.

4. The method of claim 1, wherein the composite images from the target object are sensed by any one of:
a visual/pixel device;
an infrared device;
a microwave radar device; and/or
a laser device.

5. The method of claim 4, wherein the visual/pixel device comprises any one of: a charge coupled camera (CCD) imager and/or a complimentary metal oxide semiconductor (CMOS) imager.

6. The method of claim 1, wherein the composite images are generated by a micro-polarizer array forming an array comprising a plurality of polarized pixels.

7. The method of claim 1, wherein the calculating step further comprises: extracting any one of a degree of polarization, an angle of polarization, and/or a Stokes parameter, associated with the plurality of polarized images.

8. The method of claim 1, wherein the target object comprises any one of: a moving object; and/or a stationary object.

9. The method of claim 1, further comprising generating a time history of the target object based on the composite images obtained and/or a time history of when the composite images are obtained.

10. The method of claim 8, wherein the time history captures any one of: the absolute position of the target object; and/or the relative position of the target object in relation to the vehicle.

11. The method of claim 1, further comprising establishing a set of evasive maneuver instructions for the respective hazard associated with the target object.

12. A system for avoiding collision between a vehicle and a target object, comprising:
a polarimetric imager, comprising:
one or more sensors for sensing a plurality of images from the target object;
one or more polarimetric devices operable to generate a plurality of polarized images from the sensed images; and
a composite image system operable to calculate one or more composite images from two or more of the polarized images by performing an algebraic manipulation between the two or more polarized images; and
a tracking system operable to track the target object based on the composite images.

13. The system of claim 12, wherein the vehicle comprises an unmanned vehicle and further comprises at least one of:
an unmanned spacecraft (AS) and/or unmanned aircraft system (UAS);
an unmanned aerial vehicle (UAV);
a remote-piloted vehicle (RPV);
an unmanned air combat vehicle (UCAV);
a remotely operated aircraft (ROA);
a drone;
a rocket; and/or
a missile.

14. The system of claim 12, wherein the vehicle is a manned vehicle and further comprises a vehicle operated in an unmanned capacity, wherein the vehicle comprises at least one of:
a commercial airplane and/or a jet;
a water vessel comprising at least one of: a boat and/or a ship;
a road vehicle;
a rail vehicle; and/or
a space-going vehicle.

15. The system of claim 12, wherein the composite images from the target object are sensed by any one of:
a visual/pixel device;
an infrared device;
a microwave radar device; and/or
a laser device.

16. The system of claim 15, wherein the visual/pixel device comprises any one of: a charge coupled camera (CCD) imager and/or a complimentary metal oxide semiconductor (CMOS) imager.

17. The system of claim 12, wherein the composite images are generated by a micro-polarizer array forming an array comprising a plurality of polarized pixels.

18. The system of claim 12, wherein the calculating step further comprises:
extracting any one of a degree of polarization, an angle of polarization, and/or a Stokes parameter, associated with the plurality of polarized images.

19. The system of claim 12, further comprising:
an avoidance system operable to establish a set of evasive maneuver instructions for the respective hazard associated with the target object.

20. A machine-readable medium that provides instructions, which when executed by a computing platform, causes the computing platform to perform operations comprising a method for avoiding collision between a vehicle and a target object, the method comprising:
sensing a plurality of images from the target object;
generating a plurality of polarized images from the sensed images;
calculating one or more composite images from two or more of the polarized images by performing an algebraic manipulation between the two or more polarized images; and
tracking the target object based on the composite images.
